(19) United States
(12) Patent Application Publication
(10) Pub. No.: US 2011/0193482 A1
(43) Pub. Date: Aug. 11, 2011

(54) Table Lamp with Emergency Back Up Light

(76) Inventor: Keene Jones, Richmond, KY (US)

(21) Appl. No.: 12/856,859

(22) Filed: Aug. 16, 2010

Related U.S. Application Data
(60) Provisional application No. 61/274,610, filed on Aug. 19, 2009.

(51) Int. Cl. H05B 39/10

(52) U.S. Cl. 315/87

(57) ABSTRACT

A table lamp with an emergency back up light mounted in the base is disclosed. The base will be clear or opaque such that the light from the back up light can illuminate the area. There is an electronic charger and relay switch located in the base of the lamp, a battery attached to the relay, and a pair of low wattage bulbs attached to the relay. In the event of a power outage the relay will sense the outage and switch on the back up lamps to provide emergency back up lighting.

### CROSS REFERENCE TO RELATED APPLICATIONS

This application claims priority to U.S. provisional application Ser. No. 61/274,610 filed on Aug. 19, 2009, and incorporated herein by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to an emergency back up light contained in a conventional table lamp.

2. Description of the Related Art

There are numerous commercial and industrial emergency lighting systems which cannot easily be installed in a home, due to the fact they are designed for non-residential applications. They must be affixed to a wall or ceiling, hard wired and cannot be moved to different areas of the home. These industrial lightly systems are also not designed for the aesthetic of household use. There is a need, therefore, for an emergency back up light specifically designed for household use.

### SUMMARY OF THE INVENTION

This invention provides table lamp with battery backup lighting as to provide a temporary functional light source in the event of a power outage. When power outages occur at night, there is the danger of navigating through a home to try and locate a flashlight or candle. Especially with children and the elderly the possibility of tripping over or running into many different items in the home is a problem. More so a problem is the risk of falling down stairs. This invention is meant to be an emergency source of light in the home. This invention will, in the event of a power outage, give people enough light to safely move around in their home for up to approximately 12 hours and better prepare for an extended outage by gathering other items such as candles, flashlights, firewood and other safety items.

### BRIEF DESCRIPTION OF THE DRAWINGS

FIG. 1 is a perspective view of one embodiment of the invention.

FIG. 2 is a perspective view of a second embodiment of the invention

FIG. 3 is a schematic of the invention.

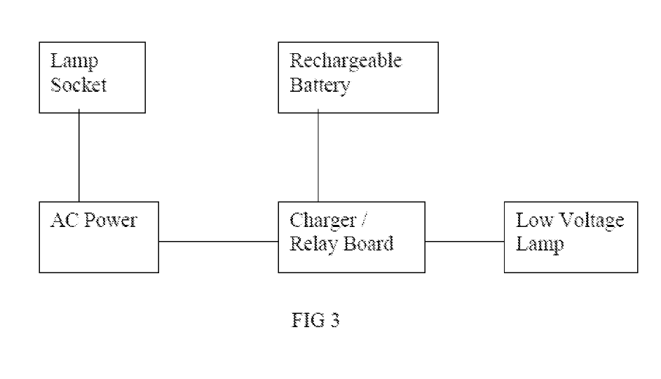

### DETAILED DESCRIPTION OF THE INVENTION

Detailed embodiments of the present invention are disclosed herein. It is to be understood that the disclosed embodiments are merely exemplary of the invention, and that there may be a variety of other alternate embodiments. The figures are not necessarily to scale, and some features may be exaggerated or minimized to show details of particular components. Therefore, specified structural and functional details disclosed herein are not to be interpreted as limiting, but merely as a basis for teaching one skilled in the art to employ the varying embodiments of the present invention.

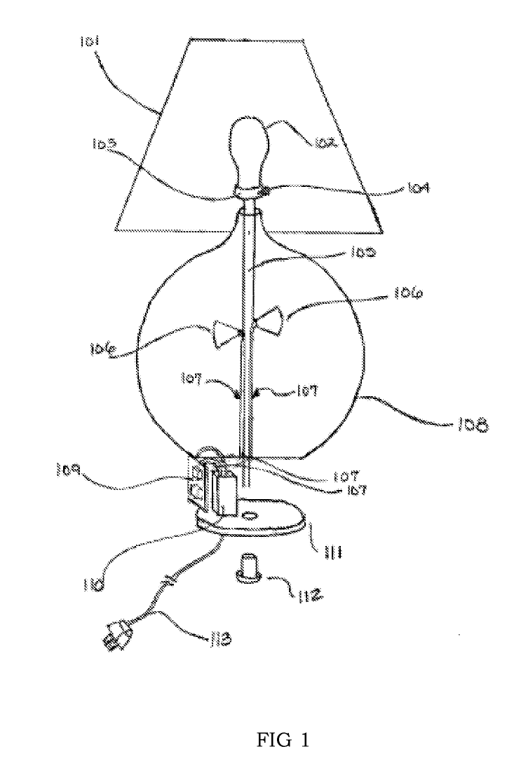

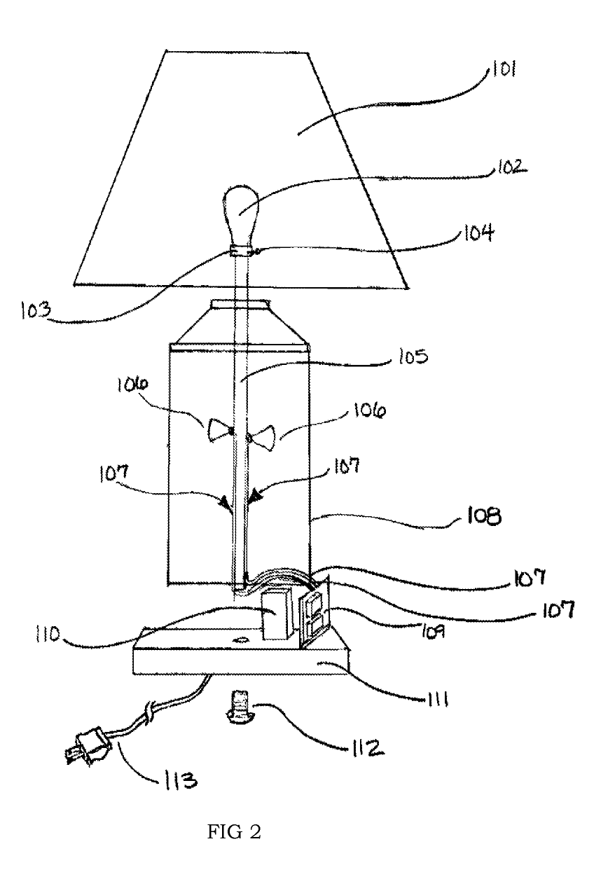

The invention can best be seen in FIG. 1 & FIG. 2. The two embodiments are essentially the same, the primary difference is the configuration of the lamp body. The lamp is built by assembling a lamp body 108 onto a base 111. The body 108 is hollow and can be made of opaque glass, colored glass, opaque plastic, perforated metal or other perforated material as to allow for a light source to illuminate through and beyond the lamp body. The lamp body 108 begins at the base 111 with a diameter sufficient to allow for a minimum 6″ clearance inside of the base of the lamp body 108. Differing body designs can allow for varying lamp body 108 heights. The base is approximately 6″ across minimum and can be square, round, rectangular, or octagonal or another shape which will allow for approximately 6″ minimum across a center point on the base inside of the lamp body 108 as to allow room for the battery 110 and charger/relay board 109.

Inside the body 108 and mounted on the base 111 there is a battery 110 and a charger/relay 109. There is an access opening in the lamp body 108 or base 111 for access to the battery and charger/relay board. There is a center rod 105 mounted on the base 111 which runs through the body 108. At the top of the center rod 105 there is mounted a conventional switched lamp socket 103 with a standard rotary switch 104 which can be either a single switched socket or a three way switched socket. Also attached to the top of the center rod 105 is a standard harp assembly on which to mount a lamp shade 101. A lamp shade of many styles and colors can be used. The socket 103 can hold a standard light bulb 102, which can be a conventional AC lamp bulb, CFL or LED bulb. The battery 110 is a 6 volt sealed rechargeable battery, and is in electronic connection with a charging board with a switching relay 109. There are at least two 6 volt halogen or led lamps 106 with low voltage leads 107 electronically connected to the charger/relay board 109. A conventional two wire PJT lamp cord 113 of sufficient length to reach from the lamp socket 103 down through the lamp body 108 and base 111 and allow at least four feet of length to extend to a wall outlet from the base 111 is also attached.

A center rod assembly 105 with a bottom fastener 112 can be used with an opening at the base 111 to extend up from the base 111 through the lamp body 108 to the lamp socket 103 as to assemble all the aforementioned components into a single unit or a rodless body with the lamp socket 103 affixed to the top of the lamp body 108.

The unit is assembled by starting with the base 111 and affixing the battery 110 to the base 111 using a conventional mounting method as to prevent the battery 110 from moving as the lamp is moved. There is a DC switch installed at the base 111 so the battery 110 can be turned off. Mount the charging/relay board 109 opposite the battery 110 and attached to the base 111. Bring the lamp cord 113 up through a nipple in the base 111 to the point of the charging/relay board 109 with approximately four feet extending outside the base 111 as to allow for plugging the lamp into a wall outlet when the lamp is put into service. The lamp cord 113 will terminate at the point of the charging/relay board 109 with the 120 volt leads from the relay board 109 and a sufficient amount of lamp cord to extend up through the center rod assembly 105 where it will terminate at the lamp socket 103.

A junction will be made including the wires to the lamp cord 113, the wire to the socket 103 and the 120 volt leads to the charger/relay board 109. The two low voltage lamps 106 will be attached to the center rod 105 approximately half-way up the height of the rod 105 inside the lamp body 108. The wires from these lamps will extend down to and terminate on the charger/relay board 109. The center rod 105 will be attached to the base 111 by an open bracket as to allow for the lamp cord 113 coming from the socket 103 to exit the rod 105 at the base 111 to the junction area near the charger/relay board 109. After this wiring is installed in the rod 105 the lamp body 108 can be installed on the base 111 with the end of the center rod 105 going up through the top of the lamp body 108 through a hole of sufficient size for the rod 105 to fit closely in the hole. The rod 105 will extend above the lamp body 108 approximately ½ inch which will allow for mounting the harp assembly and lamp socket 103. The rod 105 is threaded at the top. Installing a locknut onto the rod assembly 105 down to the top of the lamp body 108 will make the base 111 and lamp body 108 one rigid assembly. The harp will now be installed over the threaded end of the rod 105. The lamp cord 113 will be terminated on the lamp socket 103 and the socket 103 is now installed onto the end of the center rod 105 on top of the base of the harp assembly. After installing a lamp bulb 102 and lamp shade 101 the fixture can be used as a regular table lamp.

The relay board 109 has several relays for the various functions. There is an AC relay to engage the DC relay upon loss of AC power. There is a DC switching relay to engage the low voltage lamps along with a DC low voltage relay to switch off the battery when it gets too low to prevent damage to the battery 110. When standard AC power is restored the AC relay turns off the DC function and the charging function comes on to refresh the battery. It also turns off when the battery is fully charged to prevent damage from an overcharge.

The present invention is well adapted to carry out the objectives and attain both the ends and the advantages mentioned, as well as other benefits inherent therein. While the present invention has been depicted, described, and is defined by reference to particular embodiments of the invention, such reference does not imply a limitation to the invention, and no such limitation is to be inferred. The depicted and described embodiments of the invention are exemplary only, and are not exhaustive of the scope of the invention. Consequently, the present invention is intended to be limited only be the spirit and scope of the claims, giving full cognizance to equivalents in all respects.

I claim:

1. An emergency back up light contained in a table lamp comprising:
a base;
a hollow body mounted on said base;
a light socket mounted on said body wherein said light socket is sized to accommodate a standard light bulb and wherein further said light socket includes a standard light switch;
wiring means for connecting said light socket to a conventional power source;
a charger relay board electrically connected to said wire and mounted within the hollow body;
a battery in electronic connection with said charger relay board and mounted within the hollow body;
a low wattage emergency back up light electronically connected to said charger relay board and mounted within the hollow body; and
wherein said charger relay board senses the interruption of power from said conventional power source and electronically connects the battery and the back up light to provide an emergency back up light source.

2. The emergency back up light of claim one wherein said hollow body is made from a clear, translucent, opaque or perforated material to allow light from the emergency back up light to illuminate the area where the lamp is located.
